(19) United States
(12) Patent Application Publication
(10) Pub. No.: US 2025/0270060 A1
(43) Pub. Date: Aug. 28, 2025

(54) DEVICE FOR LIFTING AND MOVING A STACK OF FLAT PRODUCTS LYING ON TOP OF ONE ANOTHER

(71) Applicant: Heidelberger Druckmaschinen AG, Heidelberg (DE)

(72) Inventors: Steffen Neeb, Bensheim (DE); Suat Demir, Walldorf (DE); Michael Östreicher, Eppelheim (DE); Holger Leonhardt, Meckesheim (DE); Stefan Maier, Dielheim (DE); Ralf März, Angelbachtal (DE); Dominik Knöbl, Angelbachtal (DE)

(21) Appl. No.: 19/057,334

(22) Filed: Feb. 19, 2025

(30) Foreign Application Priority Data
Feb. 26, 2024 (DE) 10 2024 105 246.5

(51) Int. Cl. B65G 47/90

(52) U.S. Cl. CPC B65G 47/90

(57) ABSTRACT

A gripping tool for raising and moving a stack of flat products lying on top of one another, such as folded products, is preferably a robot-guided gripping tool with a horizontally movable gripper for reaching under the stack. A first actuator positions the gripper in a first horizontal position or in a second horizontal position and a second actuator establishes a horizontal additional position, such as an intermediate position, for the gripper. The device can securely grip and handle stacks of different formats and to prevent collisions of the gripper, in particular gripper tines, with stacks, with other components, or with operating personnel. The device is suitable for use in the graphics industry and in particular in the environment of folding machines or their product delivery, where stacks of folded products lying on top of one another are stacked on pallets.

### CROSS-REFERENCE TO RELATED APPLICATION

This application claims the priority, under 35 U.S.C. § 119, of German Patent Application DE 10 2024 105 246.5, filed Feb. 26, 2024; the prior application is herewith incorporated by reference in its entirety.

### FIELD AND BACKGROUND OF THE INVENTION

The invention relates to a device for lifting and moving a stack of flat products lying on top of one another.

The invention lies in the technical field of the graphics industry and, there, in particular in the field of the handling (e.g. gripping, holding, moving, rotating, turning and/or depositing) of stacks of flexible, in particular printed and folded flat products, lying on top of one another, such as folded sheets, preferably made of paper, paperboard, cardboard, plastic or composite material, by way of a manipulator, in particular a jointed-arm robot/articulated-arm robot having a robot arm and having a gripper apparatus for the stacks.

Transporting stacks of planar products on a conveyor line, such as, for instance, a roller conveyor line, and using a gripper apparatus arranged on a robot arm to grasp the stacks, lift the stacks from the conveyor line, move the stacks to a pallet located near the conveyor line and deposit the stacks there is already known in the field of post press processing. See, for instance, German published patent application DE10 2020 103 398 A1 and its counterpart U.S. Pat. No. 11,584,605 B2 or German utility model DE 2020 19106975U1 and its counterpart U.S. Pat. No. 10,968,056 B2.

French Patent FR3110152B1 discloses a conveyor line and a robot-guided gripper head. The gripper head comprises a vertically movable upper gripping element, which is in the form of a clamping element, and a horizontally movable lower gripping element, which is in the form of a pair of tines.

German published patent application DE4124077A1 discloses an apparatus for receiving flexible planar parts. The apparatus comprises move-under elements which can be moved on a linear axis.

German published patent application DE4000262A1 discloses a gripping apparatus having tines which can be moved by means of a stroke rod and a pressure cylinder and which can be extended into a gripping position.

In practice, the problem that differently sized sheets, i.e. different formats, must be raised, moved and deposited as stacks often arises. An available gripper can be optimized for a specific format and can work less optimally in the case of other formats.

### SUMMARY OF THE INVENTION

It is accordingly an object of the invention to provide a device which overcomes a variety of disadvantages associated with the heretofore-known devices and methods of this general type and which provides for an improvement over the prior art which, in particular, makes it possible to securely grip and handle stacks of different formats and to prevent collisions of the gripper, in particular gripper tines, with stacks, components or persons.

With the above and other objects in view there is provided, in accordance with the invention, a device for lifting, or raising, and moving a stack of flat products lying on top of one another. The device comprises:
a horizontally movable gripper configured for reaching under the stack;
a first actuator configured for selectively positioning said gripper in a first horizontal position or in a second horizontal position; and
a second actuator configured for establishing an additional horizontal position for said gripper.

In other words, the above and other objects are achieved, according to the invention, by a device, in particular a gripping tool and preferably a robot-guided gripping tool, for lifting and moving a stack of flat products lying on top of one another, e.g. folded products. The novel device comprises a horizontally movable gripper for reaching under the stack and a first actuator which positions the gripper in a first horizontal position or in a second horizontal position. The device further comprises a second actuator which is different from the first actuator and which establishes a horizontal additional position, preferably an intermediate position, for the gripper.

The invention advantageously makes it possible to securely grip and handle stacks of different formats and to prevent collisions of the gripper, in particular gripper tines, with stacks, components or persons.

The invention is used preferably in the graphics industry and in particular in the environment of folding machines or their product delivery, where e.g. stacks of folded products lying on top of one another are stacked on pallets.

A primary advantage of the invention is that the gripper, and thus also its (projecting) tines can—from its position largely retracted into a housing, or parking position or non-working position—be moved into and positioned in not only a single (gripping or working) position but at least two mutually different (gripping or working) positions, one of which is referred to as the additional position and in particular as intermediate position. The intermediate position, such as, for example, a half-extended position, can be used in particular for gripping and holding smaller formats, while in the completely extended position preferably large formats are handled. This results in the advantage that, in the case of smaller formats, no tines protrude (far) beyond the gripped stack and collide, during depositing, with stacks already previously deposited on pallets and shift or knock over said stacks; risks of injury to the operating personnel which result from the protruding can also be prevented in this way.

The robot arm for guiding the gripping tool is preferably part of a robot system, which usually also comprises a robot base and which can be in the form of a typical industrial robot together with fencing for operator protection, in particular in the form of a jointed-arm robot having three to seven axes of rotation, or in the form of a so-called collaborative robot system, in particular in the form of a so-called cobot (which is short for collaborative robot). The latter does not require any fencing, because the system has its own sensor equipment and uses the sensor equipment to sense contact with operating personnel and to prevent possible injuries, e.g. by means of an automatic stop of the robot arm movement. A collaborative robot system can also be realized by means of an industrial robot with additional region scanner (sensing of operating personnel in the hazard region) and with an automatic stop system, as an alternative to the cobot.

Below, preferred developments or variations of the invention (“developments” for short) are described. Where technically possible or feasible, the variants may be selectively combined with one another.

In accordance with one development of the invention, the second actuator establishes the additional position by performing a shifting movement.

A further development can be characterized in that the second actuator shifts a movable stop for the gripper or that the shifting movement moves the stop. One development can be characterized in that the stop is mounted for rotation. One development can be characterized in that the second actuator positions the stop in a passive position or in at least one active position. In the active position, the stop can act as a stop for the gripper and thereby position, in particular stop, the movable gripper in the additional position during movement of the gripper. One development can be characterized in that the stop is coupled to the second actuator by a linkage.

In accordance with another development, during retraction, the first actuator and/or the gripper stops at the stop in its active position during extension. One development can be characterized in that, during extension, the first actuator and/or the gripper moves the stop out of its active position, e.g. carries the stop along.

According to a further feature of the invention, the second actuator is preferably a pneumatic cylinder or alternatively a hydraulic cylinder or an electric cylinder.

In accordance with yet a further development the device comprises at least one additional actuator, which establishes a respective other horizontal additional position for the gripper.

In accordance with yet another development can the gripper is arranged on the device for movement relative to a frame and/or housing of the device, in particular for retraction and extension.

It should be understood that the features and combinations of features disclosed in the above descriptions of developments and in the following description of exemplary embodiments may be combined with one another to achieve additional and advantageous developments of the invention.

As an alternative, the objects of the invention may be achieved in that the second actuator shifts the gripper (into at least two positions; relative to the first actuator) or the first actuator (into at least two positions; together with the gripper) and thereby establishes the horizontal additional position for the gripper.

As another alternative, the objects can be achieved in that the first actuator establishes the horizontal additional position for the gripper, e.g. in that it moves the gripper into the additional position. In that case, the second actuator can be omitted. The first actuator can be in the form of a—preferably pneumatic—multi-position cylinder.

As yet another alternative, the objects of the invention can be achieved in that the gripper comprises movable elements, e.g. tines, which can be moved into the additional position by means of an actuator.

Other features which are considered as characteristic for the invention are set forth in the appended claims.

Although the invention is illustrated and described herein as embodied in a device for raising and moving a stack of flat products lying on top of one another, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIGS. 1 to 4 show preferred exemplary embodiments of the invention and of the developments. Corresponding features are identified with the same reference signs throughout the figures. Certain reference signs for elements that are repeatedly shown in the figures have been omitted in some cases for the sake of clarity.

FIG. 1 shows a schematic plan-view illustration of a conveyor line of a machine with a preferred embodiment of the device according to the invention.

FIG. 2 shows a sectional side view of a preferred embodiment of the device according to the invention with a stop in a passive position.

FIG. 3 shows a sectional side view of the same preferred embodiment of the device according to the invention with the stop in an active position.

FIG. 4 shows a sectional side view of another preferred embodiment of the device according to the invention with two stops.

### DETAILED DESCRIPTION OF THE INVENTION

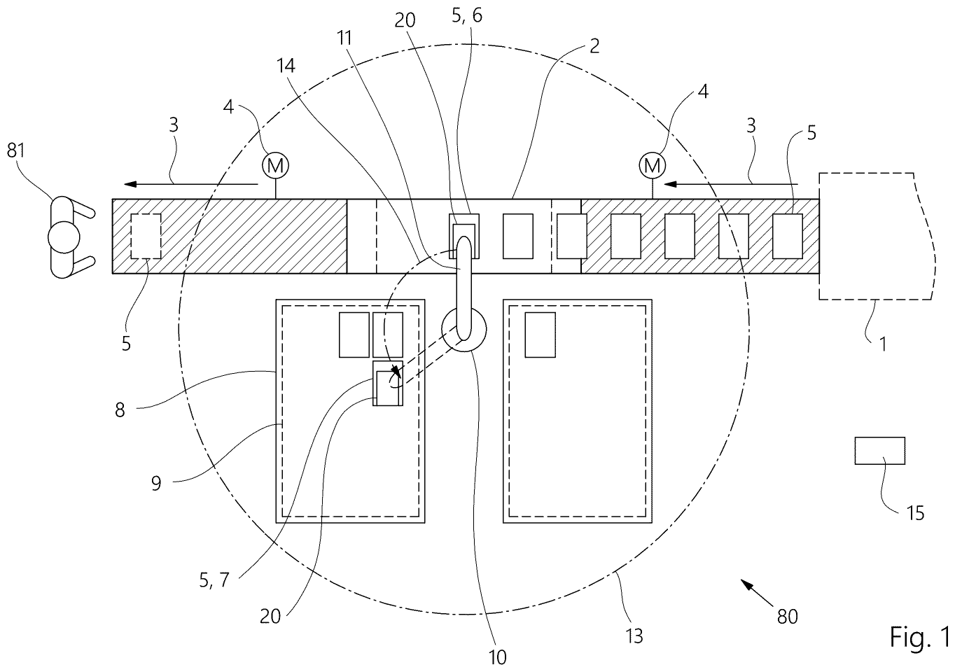

Referring now to the figures of the drawing in detail and first, in particular, to FIG. 1 thereof, there is shown a portion of a machine 1 of the graphics industry, preferably a post press processing machine 1 and in particular a folding machine 1, and a preferably linear conveyor line 2 downstream of the machine 1, for example a roller table 2 having transport rollers, with a conveying direction 3 and with at least one motor 4 for preferably horizontally conveying successive stacks 5 of products lying on top of one another, for example printed and folded sheets of paper. The machine 1 and the conveyor line 2 are arranged on a floor 80 of a production facility, for example a print shop, and can be operated by an operating person 81.

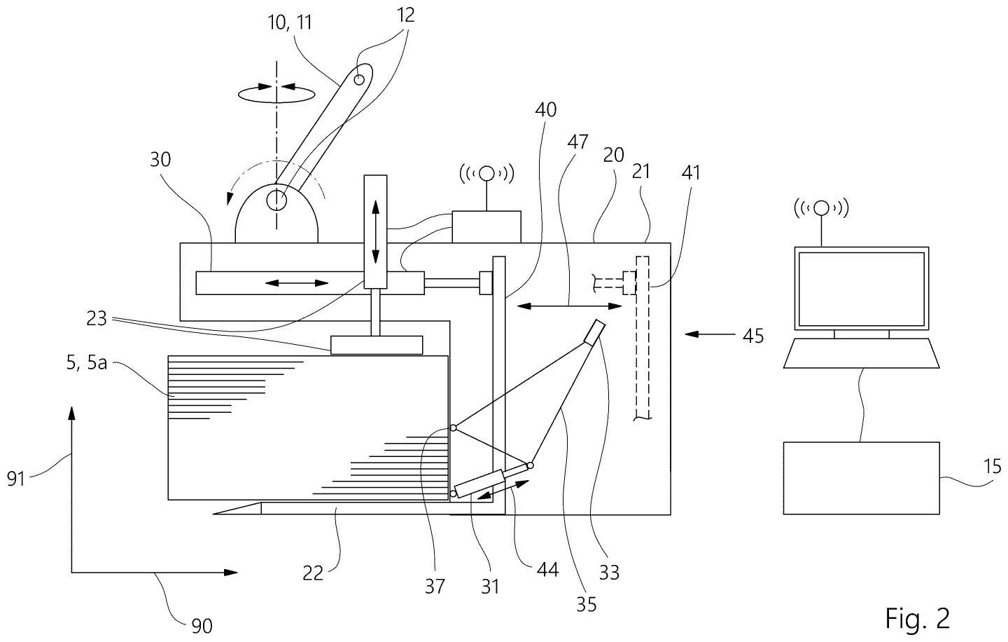

FIG. 1 also shows an apparatus for transferring the stacks 5, in particular for depositing the stacks 5 on pallets 8. The apparatus comprises a robot 10 having a movable robot arm 11, for example a jointed arm having a plurality of joints 12, on which robot arm a gripping tool 20 for gripping individual stacks 5 is arranged. A hazard region 13 is defined by the maximum movements of the robot arm 11. The gripping tool 20 grips one stack 5 at a time, lifts the stack from the conveyor line 2 and holds the stack 5 during the robot movement 14 to a pallet 8. The stacks 5 conveyed away from the machine 1 are in this way deposited one after another on the pallet 8 and form there (arranged next to one another and on top of one another according to a specified depositing scheme) a pallet stack. By way of example, in FIG. 1 two pallets 8 are placed on a longitudinal side of the conveyor line. The robot 10 is also placed on the longitudinal side of the conveyor line, by way of example; the robot could alternatively also be arranged at the end of the conveyor line 2. A controller 15 is provided which controls the movements 14 of the robot arm 11 and the movements of the grippers of the gripping tool 20 during the transfer of the stacks 5. An operator 81 can remove stacks 5 at the end of the conveyor line 2 for inspection purposes. Details of the gripping tool 20 are presented in the following FIGS. 2 to 4.

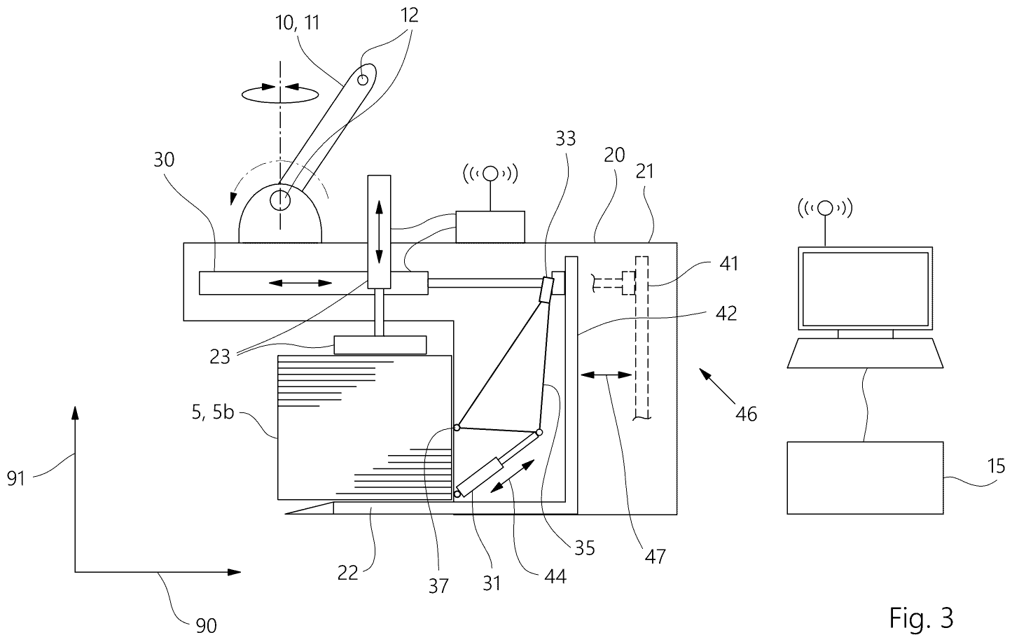

FIGS. 2 and 3 show a device 20, in particular a robot-guided gripping tool, comprising a housing 21, a horizontally (see orientation 90) movable gripper 22 and a vertically (see orientation 91) movable gripper 23 (with actuator). For the horizontal moving of the gripper 22 (relative to the housing 21), a first actuator 30 is connected to the gripper 22. The first actuator 30 makes it possible to move the gripper 22 back and forth from a first position 40 to a second position 41 or to position the gripper 22 in the two positions 40 and 41. The first position 40 is a position in which the gripper 22 grips and handles large stacks 5a (first actuator 30 retracted), and the second position 41 is a position in which the gripper 22 is completely or nearly completely retracted into the housing 21 (first actuator 30 fully extended).

According to the invention, the device 20 comprises a second actuator 31, preferably a pneumatic cylinder, which establishes or defines an additional position 42, in particular an intermediate position 42. In the additional position 42, smaller stacks 5b can be gripped and handled (the terms “large” and “small” are to be understood in relation to one another). For this purpose a stop 33, which is connected to the second actuator 31 by a linkage 35, is moved back and forth (see shifting movement 44 of the second actuator 31) between its passive position 45 (see FIG. 2) and its active position 46 (see FIG. 3) or positioned in one of the two positions 45 or 46. The linkage 35 in turn can be mounted for rotation about a pivot point 37. If the stop 33 is in the passive position 45, the gripper 22 can—as described above—be moved back and forth. If, in contrast, the stop is in the active position 46, it forms a stop for the gripper 22 in the intermediate position 42, i.e. the gripper 22 moved by the first actuator 30 can be moved back and forth only between the second position 41 and the additional position 42. If the stop 33 is moved back into or positioned in its passive position, the gripper 22 can again be moved back and forth between the first position 40 and the second position 41.

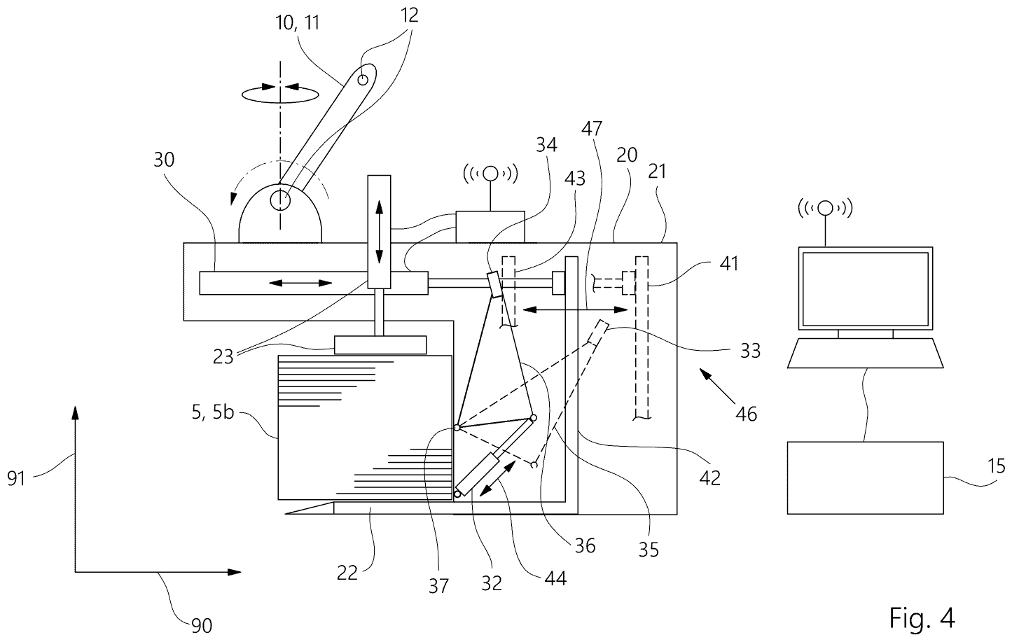

FIG. 4 shows that, besides the second actuator 31, at least one additional actuator 32 can be provided. The additional actuator 32 can move an additional stop 34 back and forth between its passive position and its active position or position said additional stop. The additional stop 34 can be connected to the additional actuator 32 by an additional linkage 36 and, for example, can be mounted for rotation about the same pivot point 37. This makes it possible to establish or define two different additional positions 42, for example two different intermediate positions, by means of the stop 33 and the additional stop 34. This in turn means that the gripper 22 can be moved back and forth between the second position 41 and one of the two additional positions 42. While the active positions of the two stops 33 and 34 differ from one another, the passive positions can be the same. The two active positions differ at least with respect to their position in the horizontal direction 90.

The following is a summary list of reference numerals and signs and the corresponding structure used in the above description of the invention:
1 Machine, in particular folding machine
2 Conveyor line, in particular roller table
3 Conveying direction
4 Motor/motors
5 Stack of flat products lying on top of one another
5a Large stack (large format)
5b Small stack (small format)
6 Receiving position, at the conveyor line
7 Depositing position, at the pallet
8 Pallet/pallets
9 Pallet stack
10 Robot/robot system
11 Robot arm
12 Joints
13 Hazard region
14 (Depositing) movement
15 Controller
20 Device, in particular gripping tool
21 Frame or housing
22 Gripper (horizontally movable)
23 Gripper (vertically movable) with actuator
30 First actuator
31 Second actuator
32 Additional actuator
33 Stop
34 Additional stop
35 Linkage
36 Additional linkage
37 Pivot point
40 First position (gripping position for large stack)
41 Second position (gripper completely retracted)
42 Additional position, in particular intermediate position (gripping position for small stack)
43 Other additional position, in particular intermediate position (gripping position for medium stack)
44 Shifting movement of actuator
45 Passive position of the stop
46 Active position of the stop
47 Shifting movement of gripper
80 Floor of a production facility
81 Operating person
90 Horizontal
91 Vertical

1. A device for lifting and moving a stack of flat products lying on top of one another, the device comprising:
a horizontally movable gripper configured for reaching under the stack;
a first actuator configured for selectively positioning said gripper in a first horizontal position or in a second horizontal position; and
a second actuator configured for establishing an additional horizontal position for said gripper.

2. The device according to claim 1, wherein said second actuator is configured to establish the additional horizontal position by performing a shifting movement.

3. The device according to claim 1, which comprises a movable stop for said gripper, and wherein said second actuator is configured to shift said movable stop for said gripper.

4. The device according to claim 3, wherein said movable stop is mounted for rotation.

5. The device according to claim 3, wherein said second actuator is configured to selectively position said movable stop in a passive position or in at least one active position.

6. The device according to claim 3, which comprises a linkage coupling said movable stop to said second actuator.

7. The device according to claim 3, wherein, during a retraction, said first actuator stops at said movable stop in an active position thereof.

8. The device according to claim 7, wherein, during an extension, said first actuator moves said movable stop out of the active position.

9. The device according to claim 1, wherein said second actuator is a cylinder device selected from the group consisting of a pneumatic cylinder, a hydraulic cylinder, and an electric cylinder.

10. The device according to claim 1, further comprising at least one additional actuator configured for establishing another additional horizontal position for said gripper.

11. The device according to claim 1, further comprising at least one of a frame or a housing, and wherein said gripper is arranged for movement relative to said frame and/or said housing of the device.
